(19) United States
(12) Patent Application Publication
(10) Pub. No.: US 2006/0071799 A1
(43) Pub. Date: Apr. 6, 2006

(54) Hand wash monitoring system and method

(76) Inventor: Vincent L. Verdiramo, Martinsville, NJ (US)

Correspondence Address: DARBY & DARBY P.C., P. O. BOX 5257, NEW YORK, NY, 10150-5257, US

(21) Appl. No.: 10/959,895

(22) Filed: Oct. 6, 2004

(51) Int. Cl. G08B 23/00

(52) U.S. Cl. 340/573.5

(57) ABSTRACT

An identification badge worn by an individual is sensed when that individual enters a lavatory. The individual is also provided with an indication device which is worn on or about the hands. Inside the lavatory, there is also provided a hand cleaning station which includes a sensor that determines whether the indicating device is in close proximity and dispenses soap on the individual's hands, then provides an appropriate indication to a computer system. Should the badge sensor sense the individual's departure from the lavatory without an appropriate indication being generated by the indicator sensor, a warning signal is generated, which is sent to the computer system and to an appropriate officer, who can then address the individual.

### FIELD OF THE INVENTION

The present invention relates generally to security systems and, more particularly, concerns a method and system for monitoring whether individuals using a lavatory or similar facility wash their hands.

### BACKGROUND OF THE INVENTION

Individuals who handle food, for example, in restaurants are at a high risk of spreading disease if they do not handle food properly. One of the most common risks occurs when such individuals do not wash their hands after using a lavatory or bathroom. For this reason, most municipalities have laws which specifically require hand washing by such individuals and also require the proprietor to post notices informing individuals that they must wash their hands before returning to work.

Nevertheless, individuals will occasionally fail to wash their hands under these circumstances, whether by inadvertence or laziness. It would therefore be desirable to have a system which could monitor individuals using a lavatory, without invading their privacy, which could assure that they wash their hands as required by law and dictated by good hygienic practice.

### SUMMARY OF THE INVENTION

In accordance with a preferred embodiment of the present invention, an identification badge worn by an individual is sensed when that individual enters a lavatory. The individual is also provided with an indication device which is worn on or about the hands. Inside the lavatory, there is also provided a hand cleaning station which includes a sensor that determines whether the indicating device is in close proximity and dispenses soap on the individual's hands, then provides an appropriate indication to a computer system. Should the badge sensor sense the individual's departure from the lavatory without receiving an appropriate indication from the indicator sensor, a warning signal is generated, which is sent to the computer system and to an appropriate officer, who can then address the individual.

### BRIEF DESCRIPTION OF THE DRAWINGS

The foregoing brief description, as well as other features and advantages of the present invention will be understood more completely from the following detailed description of a presently preferred, but nonetheless illustrative, embodiment of the invention, with reference being had to the accompanying drawings in which:

FIG. 1 is a perspective view of a hand wash monitoring system in use in conjunction with a lavatory, with an individual hands being shown inserted therein;

FIG. 2 is flowchart illustrating the operation of the hand wash monitoring system;

FIG. 3 is a functional block diagram illustrating the cooperation of the various components of a hand wash monitoring system;

FIG. 4 is an enlarged, sectional view taken along contour 4-4 in FIG. 1 and looking in the direction of the arrows to illustrate internal details of the hand cleaning station; and

FIG. 5 is a sectional view taken along line 5-5 in FIG. 1 and looking in the direction of the arrows to illustrate further internal details of the cleaning station.

### DETAILED DESCRIPTION OF THE PREFERRED EMBODIMENT

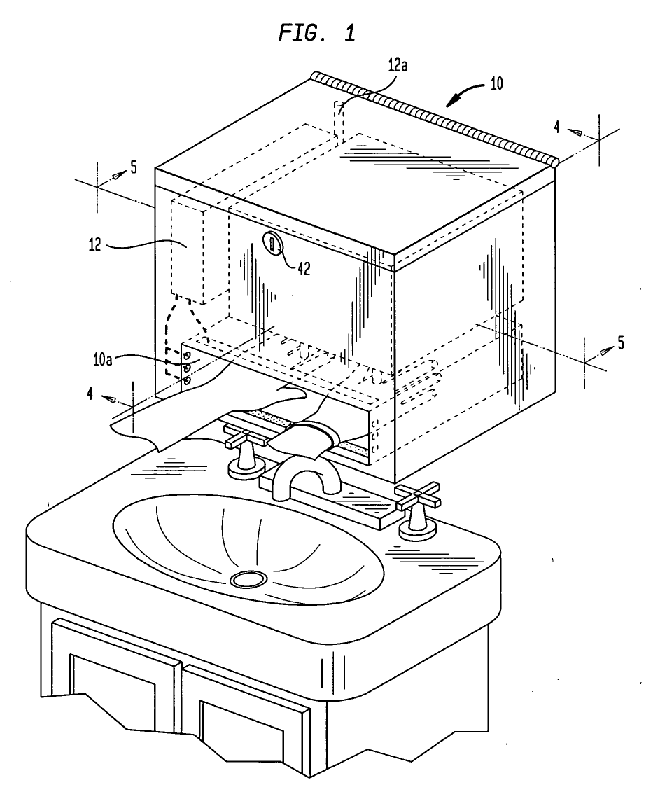

FIG. 1 is a perspective view illustrating a hand wash monitoring system S embodying the present invention, in use by an individual. A hand cleaning station 10 is provided in the washroom in close proximity to the sink, in this case just above the sink. Station 10 is provided with an opening 10a, into which an individual inserts his hands prior to washing them. As will be explained below, the insertion of the hands is sensed by the station 10, which dispenses soap. The station also provides an indication to the system that the hands have been inserted.

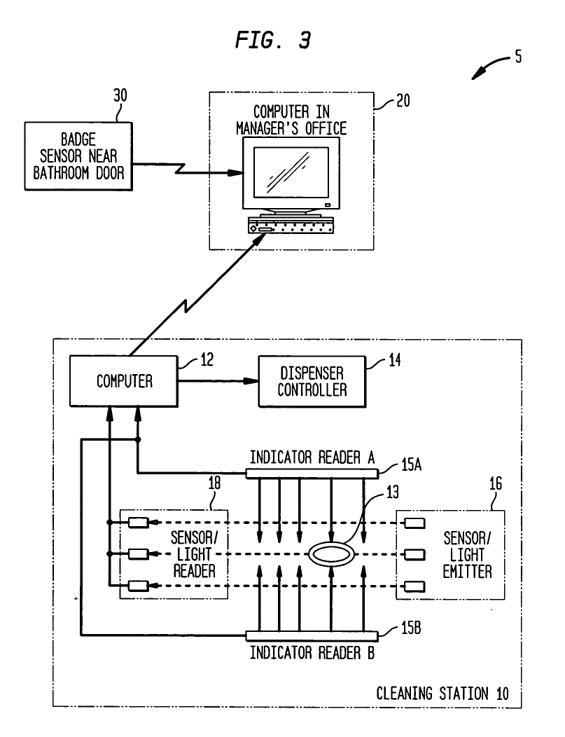

FIG. 3 is functional block diagram illustrating the major components of the hand wash system and their cooperation. The three major components are a central computer 20 provided, for example, in a manager's office; a badge sensor 30 provided near the lavatory door, where an individual would enter the lavatory; and the hand cleaning station 10 described previously. Badge sensor 30 is coupled to the computer 20, preferably wirelessly, and senses an identification badge worn by an individual when he enters the lavatory.

Hand cleaning station 10 includes a computer 12, which provides local control and communicates, preferably wirelessly, with the main computer 20. As explained below in using the present invention, the individual will wear an indicator 13 on or about his hands. In the preferred embodiment, this is a wristband. A pair of indicator readers 15A, 15B are located inside the unit 10, and positioned so that the indicating device 13 must be located between them in order to be sensed by both. At the same time, a light emitter 16 projects a series of light beams to a light reader 18. When the hands are properly positioned inside station 10, the light beam is broken and an appropriate indication is provided by light reader 18 to computer 12. Sensors which operate this way are in common use today in automatic toilets and sinks. Computer 12 then operates dispenser controller 14 so as to deposit a hand wash solution, such as soap upon the individual's hands. At the same time, indicator readers 15A, 15B provide an indication to computer 12 that the individual inserted his hands into station 10.

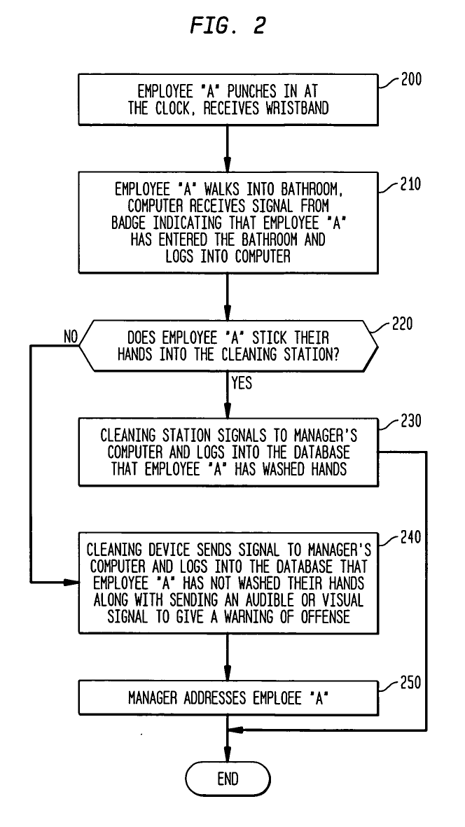

FIG. 2 is a flowchart illustrating the operation of the preferred embodiment of the present invention. In this example, it is assumed that the individual is an employee at an establishment, such as a restaurant. At step 200, the employee receives an indicator device 13 in form of a wristband when he arrives at the place of employment or punches into a clock. It will be appreciated that the indicator device could also be in the form of a ring or band worn on a finger or any other type of a device worn on or about the hands. It will also be appreciated that the indicator device could be provided to the individual at the time that he enters the bathroom. In any case, it is assumed that the establishment requires every employee to wear an identification badge. Many such types of badges are available today, including ones that can be sensed by a remote sensor as an individual wearing the badge passes. Such a sensor 30 is provided in the vicinity of the bathroom door and senses the identity of an individual passing through the door. This information and the identity of the individual are transmitted to the main computer 20 (Step 210).

As explained previously, an individual would be expected to place his hands into the hand cleaning station 10 prior to departing from the bathroom. This would cause the indicator readers 15A, 15B to sense the indicator device 13 and send an appropriate message to computer 12. At the same time, soap would be deposited upon the individual's hands, and he would need to wash his hands in order to remove it.

At step 220, a test is performed to determine whether an appropriate signal was received from indicators 15A, 15B. This could occur when badge sensor 30 senses that the individual has left the bathroom. If so, computer 12 signals to computer 20 that it has received an appropriate indication and an entry could be made in a database within computer 20 indicating that the individual washed his hands (Step 230).

Should computer 12 not have received the indication tested for in Step 220 when the individual leaves the bathroom, computer 12 signals to computer 20 that the employee failed to wash his hands and an appropriate entry made in the database (Step 240). An appropriate visual or audible alarm could also be provided to draw the attention of a manager and to indicate the identity of the individual who failed to wash his hands. The manager could then have an appropriate discussion with that individual and assure that he returns to wash his hands (Step 250).

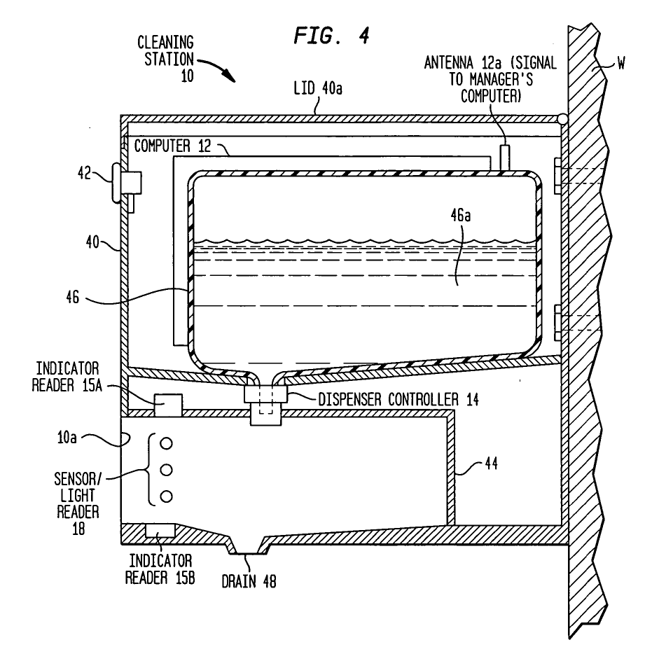

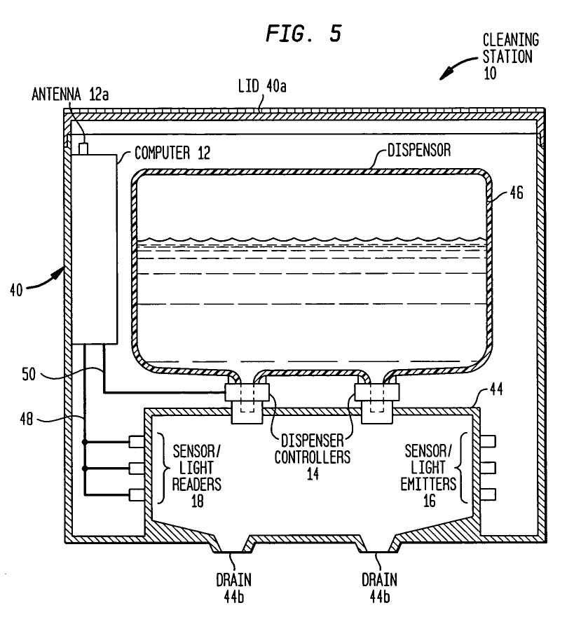

FIGS. 4 and 5 are sectional views illustrating the preferred inner construction of the cleaning station 10. As may be seen, cleaning station 10 is provided inside an enclosure 40, which includes a hinged lid 40a, through which the interior of the enclosure may be accessed. The lid is prevented from being opened by means of a lock 42. Computer 12 is mounted on the interior of the enclosure 40 and is presumed to have a wireless transmitter with an antenna 12a. Within enclosure 40, there is provided an enclosed compartment 44 which is accessed via opening 10a. Above the compartment 44, there is provided a tank 46 containing soap solution 46a. Tank 46 communicates with compartment 44 through the dispenser controllers 14, which enter compartment 44 from above.

Indicator readers 15A and 15B are provided near the front of compartment 44 in upper and lower walls, respectively. Also, light emitters 16 are provided on a right-hand wall of compartment 44 and light readers 18 are provided on the left-hand wall, with both in positions to assure that the light beam is broken when the individual's hands are inserted into compartment 44. In the bottom wall of compartment 44, there are provided drains 44b, 44b, which permits excess soap solution to be disposed through the sink which lies below. Computer 12 is coupled to sensors 18 via leads 48 and to controller 14 via leads 50. As may be seen in FIG. 4, the enclosure 40 is conveniently mounted, by conventional means, to a wall W within the lavatory.

Although a preferred embodiment of the invention has been disclosed for illustrative purposes, those skilled in the art will appreciate that many additions, modifications and substitutions are possible, without departing from the scope and spirit of the present invention as defined by the accompanying claims.

I claim:

1. A system for monitoring hand cleaning at a cleaning station by an individual wearing an identification device containing a code identifying the individual and also wearing an indicating device in the proximity of his hands, comprising
an identity sensor proximate the cleaning station sensing the presence of the identification device;
an indicating device sensor at the cleaning station positioned to sense the presence of the indicating device in the cleaning station; and
an alarm generator providing a warning signal when the individual has left the vicinity of the cleaning station and the indicating device sensor has not sensed the presence of the indicating device.

2. The system of claim 1 wherein the cleaning station is in an enclosed area accessed by a door and the identity sensor is located in the vicinity of the door in a position to sense the entry and departure of the individual to and from the enclosed area.

3. The system of claim 1 further comprising a computer disposed in the cleaning station, the computer being connected to identity sensor and the indicating device sensor and to receive a signal from each the signal from the identity sensor identifying the individual and the signal from the indicating device sensor relating to the indicating device being sensed, the alarm generator being part of the computer.

4. The system of claim 3 wherein the computer further comprises a transmitter which communicates with a location remote from the cleaning station.

5. The system of claim 1 further comprising a hand sensor for sensing the presence of the individual's hands in a particular are of the cleaning station, a container for cleaning solution, and a dispensing controller responsive to the hand sensor to dispense cleaning solution from said container into said particular area.

6. The system of claim 1 further comprising a warning transmitter for transmitting the warning signal to a remote computer.

7. The system of claim 6 further comprising a local computer disposed in the cleaning station, the computer being connected to identity sensor and the indicating device sensor and to receive a signal from each the signal from the identity sensor identifying the individual and the signal from the indicating device sensor relating to the indicating device being sensed, the alarm generator and warning transmitter being part of the local computer.

8. The method of claim 1 Further comprising an enclosure for the cleaning station, the enclosure having an enclosed compartment and an opening providing access to the compartment, the indicating device sensor having access to the compartment.

9. The system of claim 8 further comprising a hand sensor having access to the compartment for sensing the presence of the individual's hands in the compartment, a container for cleaning solution, and a dispensing controller responsive to the hand sensor to dispense cleaning solution from said container into said compartment.

10. A method for monitoring hand cleaning at a cleaning station by an individual wearing an identification device containing a code identifying the individual and also wearing an indicating device in the proximity of his hands, comprising:
sensing the presence of the identification device in the proximity the cleaning station;
sensing the when the indicating device is present in the cleaning station; and
generating a warning signal when the identification device has left the vicinity of the cleaning station and the presence of the indicating device in the cleaning station has not been sensed.

11. The method of claim 10 performed with a cleaning station which is in an enclosed area accessed by a door, an identity sensor is located in the vicinity of the door in a position to sense the entry and departure of the individual to and from the enclosed area, the step of sensing the presence of the identification device being performed by the identity sensor.

12. The method of claim 11 wherein a computer is disposed in the cleaning station, the computer being coupled to the identity sensor, there being further provided an indicating device sensor to perform the step of sensing when the indicating device is present, the computer being coupled to the indicating device sensor, the generating step being performed by the computer in response to the identity sensor and the indicating device sensor.

13. The method of claim 10 further comprising the step of transmitting the warning signal to a location remote from the cleaning station.

14. The method of claim 10 further comprising sensing the presence of the individual's hands in a particular are of the cleaning station and dispensing a cleaning solution from a container into said particular area.

15. The method of claim 10 further comprising transmitting the warning signal and the individual's identity to a remote computer.
